(19) United States
(12) Patent Application Publication
(10) Pub. No.: US 2014/0121873 A1
(43) Pub. Date: May 1, 2014

(54) CONTROL SYSTEM AND METHOD FOR HYBRID VEHICLE

(71) Applicants: HYUNDAI MOTOR COMPANY, Seoul (KR); KIA MOTORS CORPORATION, Seoul (KR)

(72) Inventors: Nam II Choi, Hwaseong (KR); Woo Suk Choi, Yongin (KR); Jong Bum Oh, Hwaseong (KR); Kyung Taek Lee, Seoul (KR)

(73) Assignees: KIA MOTORS CORPORATION, Seoul (KR); HYUNDAI MOTOR COMPANY, Seoul (KR)

(21) Appl. No.: 13/713,891

(22) Filed: Dec. 13, 2012

(30) Foreign Application Priority Data
Oct. 26, 2012 (KR) 10-2012-0120003

(51) Int. Cl. B60W 20/00

(52) U.S. Cl. CPC B60W 20/10
USPC 701/22; 180/65.275; 903/902

(57) ABSTRACT

Disclosed is a control method that improves response delay by reducing the time taken to determine the engagement type of an engine clutch, by making it possible to determine quickly the engagement type by a slip process under a disadvantageous operating conditions for the synchronization process such as traveling up a slope, traveling in a congestion section, or traveling under to or close to a discharging limit, and can improve fuel efficiency and battery SOC management due to unnecessarily using electric energy when engagement cannot be achieved by the synchronization process.

### CROSS-REFERENCE TO RELATED APPLICATION

This application claims under 35 U.S.C. §119(a) the benefit of Korean Patent Application No. 10-2012-0120003 filed Oct. 26, 2012 the entire contents of which are incorporated herein by reference.

### BACKGROUND

(a) Technical Field

The present invention relates to a control system and method for a hybrid vehicle, and more particularly, to a system and method of controlling an engine clutch in a vehicle equipped with a parallel type hybrid power train with a TMED (Transmission Mounted Electric Device).

(b) Background Art

A TMED of hybrid power train changes an operation mode by engaging/disengaging an engine clutch disposed between an engine and a motor. To control the engine clutch, there are at least two types of processes currently available. One of these processes is a synchronization process, in this process the speed of the engine-motor and acceleration speed are synchronized and a hydraulic engagement pressure is applied at a predetermined time. Alternatively, a slipping process can be used which induces the engine-motor to slip while gradually applying a hydraulic pressure by calculating necessary transmission torque in order utilize the engine torque. A hydraulic engagement pressure is then applied once a motor is at or above a predetermined speed.

In order for synchronization process to properly be performed a specific time needs to be set during configuration. Furthermore, power from the engine during synchronization is not transferred to the wheels and thus only the torque from the motor is being applied to the wheel. As a result, during synchronization, the battery runs out rapidly. However, by utilizing the synchronization process the system can rapidly supply the torque that is required by the driver because the engagement time is reduced in accordance with the control level during the synchronization.

Furthermore, although the above reference slipping process transfers power to the wheels via the torque resulting from inducing slip by applying a hydraulic pressure to an engine clutch, before the engine clutch is completely engaged, so that relatively less electric energy is consumed so that the SOC of a battery can be maintained, the performance of the power train varies, depending on the available engine torque and the hydraulic property of the engine clutch under certain environmental conditions. Furthermore, the application of the hydraulic pressure is limited, depending on an idle control level of the engine, so that it is difficult to rapidly supply torque that is required by the driver.

In the related art, as illustrated in FIG. 1, when an EV mode is switched to an HEV mode, it is determined whether a motor speed has reached a reference speed for a predetermined amount of time, with the motor speed, which can ensure a stable operation of the engine, as the reference speed when the engine clutch is completely engaged, the engine clutch is controlled via the synchronization process when the reference speed is reached, and the engine clutch attempts to engage during the synchronization process. After a certain amount of time passes, if the clutch is still not engages, the system engages the engine clutch via the slipping process.

However, the above control method takes a certain amount of time to determine which type of engagement will be used, depending on the current operating conditions. As a result the amount of time it takes for the engine clutch to engage is increase, and undesired shock is generated when the engagement type is switched (i.e., when the clutch does not engage via the synchronization process). Thus, electric energy and fuel are unnecessarily being consumed and fuel efficiency and the SOC is not maintained. This is because the synchronization process is being attempted under an operational circumstance where the environmental factors or the operating conditions, such as traveling up a slope or traveling at a low speed in a city, is difficult to satisfy the engagement conditions required to properly perform a synchronization process.

The description provided above as a related art of the present invention is just for helping understanding the background of the present invention and should not be construed as being included in the related art known by those skilled in the art.

### SUMMARY OF THE DISCLOSURE

The present invention provides a control system and method for a hybrid vehicle that can improve response delay by reducing the time taken to determine the type of engagement that will be used to engage an engine clutch, by dynamically making a determination to use a slip process when operating conditions for properly performing a synchronization process such as traveling up a slope, traveling in a congestion area, or traveling under a discharging limit are present. The above control method as a result improves fuel efficiency and SOC issues due to unnecessarily using electric energy during circumstances where engagement cannot be achieved via the synchronization process.

In order to achieve the object of the present invention, a control method for a hybrid vehicle executed by a processor within a controller installed in the hybrid vehicle. More specifically, this method includes: a discharge power calculation process configured to calculate discharge power according to a current status of a battery mounted within a vehicle; a speed limit calculation process configured to calculate a motor torque limit time speed (i.e., a motor speed at which the torque from a motor starts rapidly decreasing in accordance with the calculated discharge power); a reference speed calculation process configured to calculate a reference motor speed that ensures stable operation of an engine when an engine clutch is completely engaged, using the current driving force and traveling resistance of the vehicle; a speed comparison process configured to compare the motor torque limit time speed with the reference motor speed; a synchronization process performing process configured to engage the engine clutch via a synchronization process when the motor torque limit time speed is equal to the reference motor speed or more, as the result of performing the speed comparison process; a torque comparison process configured to determine whether motor torque limit according to the discharge power is driver-requesting torque, when the motor torque limit time speed is less than the reference motor speed, as the result of performing the speed comparison process; and a slip process performing process configured to engage the engine clutch via a slip process, when the motor torque limit is less than the driver-requesting torque, as the result of performing the torque comparison process.

Further, the present invention provides a control method for a hybrid vehicle executed by a processor within a controller installed in the hybrid vehicle. More specifically, this method includes: a speed limit calculation process configured to calculate a motor torque limit time speed (a motor speed at which the torque of a motor starts to rapidly decrease), in accordance with discharge power of a battery mounted on a vehicle; an engagement possibility determining process configured to determine whether an engine clutch can be engaged within a time that it takes for the current motor speed to reach the motor torque limit time speed due to an increase in vehicle speed via an auxiliary driving force of a vehicle, considering the current driving force and traveling resistance; a synchronization process performing process that engages the engine clutch in a synchronization process, when the processor determines that the engine clutch can be engaged within the time that takes the current motor speed reaches the motor torque limit time speed; a torque comparison process that determines whether motor torque limit according to the discharge power is driver-requesting torque or more, when the processor determines that the engine clutch cannot be engaged within the time that is required for the current motor speed to reach the motor torque limit time speed; and a slip process performing process that engages the engine clutch in a slip process, when the motor torque limit is less than the driver-requesting torque, as the result of performing the torque comparison process.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a flowchart illustrating a control method for a hybrid vehicle according to the related art.

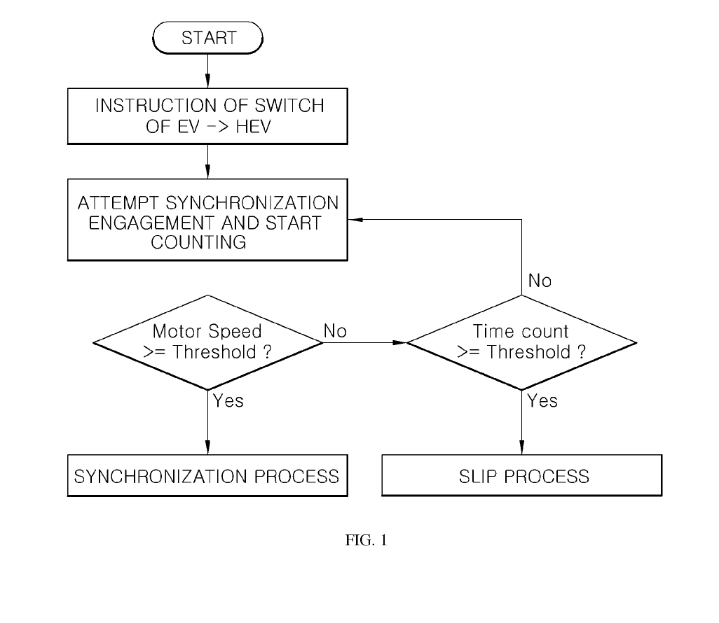

FIG. 2 is a flowchart illustrating an example of a control method for a hybrid vehicle according to the present invention.

FIG. 3 is a graph showing the relationship between speed and torque of a motor according to discharging power of a battery.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Hereinafter reference will now be made in detail to various embodiments of the present invention, examples of which are illustrated in the accompanying drawings and described below.

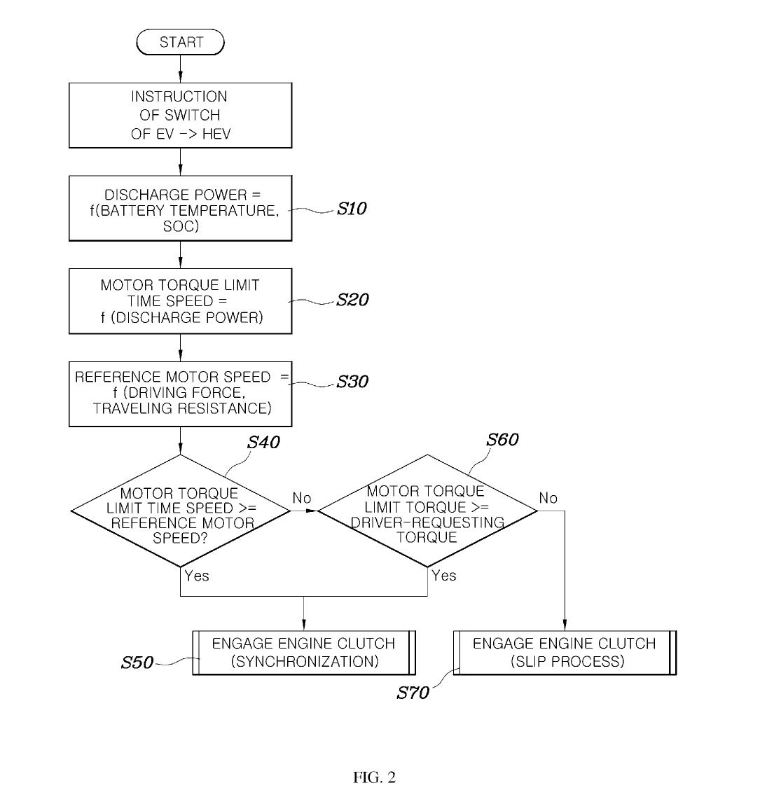

Referring to FIG. 2, a control method for a hybrid vehicle of the present invention includes: a discharge power calculation process (S10) that calculates discharge power according to the current status of a battery mounted on a vehicle; a speed limit calculation process (S20) that calculates a motor torque limit time speed which refers to a motor speed at which the torque of a motor starts rapidly decreasing in accordance with the calculated discharge power; a reference speed calculation process (S30) that calculates a reference motor speed that ensures stable operation of an engine when an engine clutch is completely engaged, using the current driving force and traveling resistance of the vehicle; a speed comparison process (S40) that compares the motor torque limit time speed with the reference motor speed; a synchronization process performing process (S50) that engages the engine clutch via a synchronization process when the motor torque limit time speed is equal to the reference motor speed or more, as the result of performing the speed comparison process (S40); a torque comparison process (S60) that determines whether motor torque limit according to the discharge power is a driver-requesting torque, when the motor torque limit time speed is less than the reference motor speed, as the result of performing the speed comparison process (S40); and a slip process performing process (S70) that engages the engine clutch in a slip process, when the motor torque limit is less than the driver-requesting torque, as the result of performing the torque comparison process (S60).

That is, when an instruction from the processor of a controller installed in a vehicle is received which switches EV (electric vehicle) traveling status to an HEV (hybrid electric vehicle) traveling status is given by a driver operating an acceleration pedal, the processor determines whether the torque of the motor is rapidly decreasing, when the speed of the motor increases and reaches a predetermined speed, according to the current status of the vehicle by the discharge power calculation process (S10) and the speed limit calculation process (S20). Additionally, the processor determines whether to engage the engine clutch via either a synchronization process or a slip process by identifying a reference motor speed corresponding to the vehicle speed which can ensure stable operation of the engine when the engine clutch is completely engaged, in consideration of the current driving force and traveling resistance of the vehicle, and comparing the reference motor speed through the speed comparison process (S40).

Discharge power is calculated from the current temperature and SOC (State of Charge) of the battery in the discharge power calculation process (S10) and may be determined in accordance with the corresponding temperature or SOC by examining the battery in advance, and stored in a map database of a memory within, e.g., the controller or another controller in the vehicle.

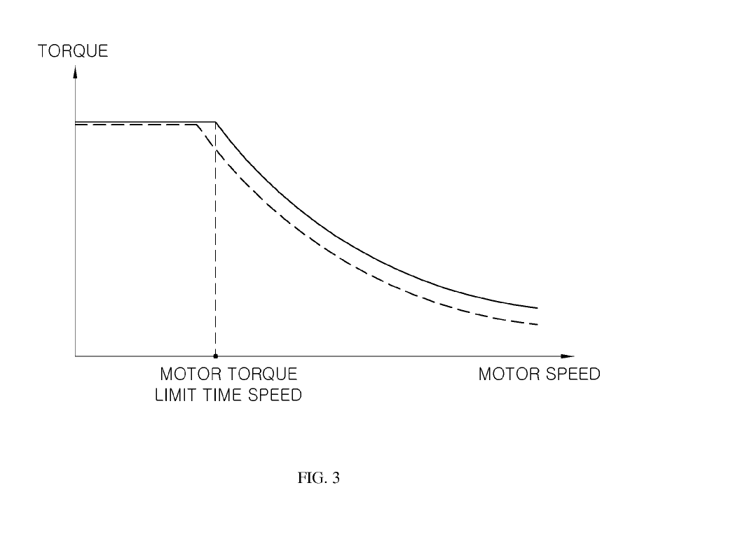

The motor torque limit time speed is calculated from a torque curve for the speed of the motor according to the discharge power of the battery, shown in FIG. 3, is calculated in the speed limit calculation process (S20). The torque curve in relation to the speed of the motor shown in FIG. 3 shows the natural characteristics of the motor which are stored in advance for each discharge power by an examination and data processing conducted by the manufacture, and the speed at the position where the torque, that has been previously kept substantially constant, starts to rapidly decrease with an increase in the speed of the motor, as shown in FIG. 3, by selecting a curve corresponding to the discharge power determined in the discharge power calculation process (S10), as the motor torque limit time speed.

For reference, in FIG. 3, a torque curve for the speed of a motor for one discharge power is indicated by a solid line and a torque curve to another discharge power indicated by a dotted line is shown as an example.

In the reference speed calculation process (S30), an acceleration speed of the vehicle is calculated by using the current driving force and traveling resistance. Next, the necessary time required to reach a vehicle speed that can ensure stable operation of the engine when the engine clutch is completely engaged from the current vehicle speed is calculated by integrating the acceleration speed with an integration area from the current vehicle speed to the vehicle speed that can ensure stable operation of the engine when the engine clutch is completely engaged. Subsequently, a reference vehicle speed is found by integrating the acceleration speed of the vehicle to a reference vehicle speed, with an integration area from 0 to the necessary time. The speed of an input shaft of a transmission is then calculated in consideration of an effective radii of the driving wheels and the total reduction gear ratio of the vehicle in the reference vehicle. Finally, the speed of the input shaft of the transmission is set as the reference motor speed.

That is, since the current driving force is in the EV operational mode, the torque of the motor can be divided by the effective radii of the driving wheels, a auxiliary driving force can be found by subtracting the traveling resistance under the current operating conditions from the driving force, and the acceleration speed of the vehicle can be found, considering the auxiliary driving force, rolling resistance of the vehicle, air resistance, slope resistance, and acceleration resistance, which would be well understood by those skilled in the art, therefore description of this has been omitted.

The necessary time for reaching the vehicle speed that can ensure stable operation of the engine when the engine clutch is completely engaged from the current vehicle speed is calculated by integrating the acceleration speed, which is found as described above, to a speed with the integration area from the current vehicle speed to the vehicle speed that can ensure stable operation of the engine when the engine clutch is completely engaged. As a result, it is possible to calculate the vehicle speed that can ensure stable operation of the engine when the engine clutch is completely engaged, in consideration of an engine speed that can ensure a stable operation of the engine when the engine clutch is completely engaged in terms of design by an experiment and analysis conducted in advance by the manufacture, the total reduction gear ratio of the vehicle according to the current shifting gear, and the effective radii of the driving wheels.

When the reference speed is found by integrating the acceleration speed of the vehicle, which is found from the current driving force and traveling resistance of the vehicle, to time with an integration area from 0 to the necessary time, by using the necessary time found as described above and the speed of the input shaft of the transmission may be calculated in consideration of the total reduction gear ratio and the effective radii of the driving wheels in the reference vehicle speed. The speed of the input shaft of the transmission calculated as described above is the reference motor speed that is a unit that can be compared with the motor torque limit time speed and is compared in the speed comparison process (S40).

As a result, considering the current driving force and traveling resistance of the vehicle, comparing the motor torque limit time speed with the reference vehicle speed and the reference motor speed found in accordance with the necessary time found in consideration of the current driving force and traveling resistance of the vehicle, as described above, means determining whether the engine clutch can be engaged within the time that takes the current motor speed to reach the motor torque limit time speed due to an increase in vehicle speed by the auxiliary driving force of the vehicle, which is described as an engagement possibility determining process in the claims.

That is, the synchronization process performing process (S50) is performed, when the engine clutch can be engaged within the time that takes for the current motor speed to reach the motor torque limit time speed, considering the current driving force and traveling resistance of the vehicle, or if not, when the motor torque limit is less than the driver-requesting torque, as the result of performing the torque comparison process (S60) is performed, the slip process performing process (S70) is performed.

On the other hand, when the motor torque limit is greater than the driver-requesting torque, as the result of performing the torque comparison process (S60), the synchronization process performing process (S50) is performed.

Obviously, the driver-requesting torque is determined in accordance with the amount of operation of the acceleration pedal by the driver and it is determined that the torque generated by the motor satisfies a request of the driver from the fact that the motor torque limit is greater the driver-requesting torque, so that it is not necessary to supply the power of the engine to the driving wheels, using the slip process, before the engine clutch is completely engaged. Therefore, the engine clutch can be engaged by the synchronization process to take advantage of relatively different advantages, whereas when the motor torque limit is less than the driver-requesting torque, the power of the engine can be transmitted to the driving wheels by the slip process, even before the engine clutch is completely engaged. Thus, the above process allows for a dynamic clutch engagement based on current operation conditions being experienced by the vehicle.

According to the present invention described above, it is possible to quickly determine an appropriate engagement process via either the synchronization process or the slip process when switching from an EV mode to a HEV mode, in accordance with the operating conditions of a vehicle.

Therefore, it is possible to improve response delay, which is one of the problems in the slip process, by reducing the time taken to determine the engagement process, by determining quickly when it is necessary to engage the engine clutch via the slip process under traveling conditions that are disadvantageous for the synchronization process such as traveling up a slope, traveling in a congestion section, and traveling under limited discharge circumstances. Additionally, it is also possible to improve fuel efficiency and SOC due to unnecessary use of electric energy under a circumstance where the engagement cannot be achieved via the synchronization process.

Although the present invention was described with reference to specific embodiments shown in the drawings, it is apparent to those skilled in the art that the present invention may be changed and modified in various ways without departing from the scope of the present invention, which is described in the following claims.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A control method for a hybrid vehicle executed by a processor within a controller, the method, comprising:
calculating, by the processor, a discharge power according to a current status of a battery mounted within the hybrid vehicle;
calculating, by the processor, a motor torque limit time speed wherein the motor torque limit speed is a motor speed at which a torque of a motor starts rapidly decreasing in accordance with the calculated discharge power;
calculating, by the processor, a reference motor speed that ensures stable operation of an engine when an engine clutch is completely engaged, using a current driving force and traveling resistance of the vehicle;
comparing, by the processor, the motor torque limit time speed with the reference motor speed;
engaging, by the processor, the engine clutch via a synchronization process when the motor torque limit time speed is the reference motor speed or more, as the result of performing the speed comparison process;
determining, by the processor, whether the motor torque limit according to the discharge power is a driver-requesting torque, when the motor torque limit time speed is less than the reference motor speed; and
engaging, by the processor, the engine clutch via a slip process, when the motor torque limit is less than the driver-requesting torque.

2. The method of claim 1, wherein discharge power is calculated from a current temperature and a state of charge (SOC) of the battery.

3. The method of claim 1, further comprising:
calculating an acceleration speed of the vehicle by using the current driving force and traveling resistance;
calculating a necessary time to be taken to reach a vehicle speed that ensures stable operation of the engine when the engine clutch is completely engaged from the current vehicle speed by integrating the acceleration speed with an integration area from the current vehicle speed to the vehicle speed that ensures stable operation of the engine when the engine clutch is completely engaged;
calculating a reference vehicle speed by integrating the acceleration speed of the vehicle to a reference vehicle speed, with an integration area from 0 to the necessary time;
calculating a speed of an input shaft of a transmission in consideration of an effective radii of one or more driving wheels and the total reduction gear ratio of the vehicle in the reference vehicle; and
setting the speed of the input shaft of the transmission as the reference motor speed.

4. The method of claim 1, wherein when the motor torque limit is greater than the driver-requesting torque, the synchronization process is performed.

5. A control method for a hybrid vehicle executed by a processor within a controller, the method comprising:
calculating, by the processor, a motor torque limit time speed, wherein the motor torque limit speed is a motor speed at which a torque of a motor starts to rapidly decrease, in accordance with discharge power of a battery mounted within the vehicle;
determining, by the processor, whether an engine clutch can be engaged within a time required for a current motor speed to reach the motor torque limit time speed due to an increase in vehicle speed by an auxiliary driving force of a vehicle, considering a current driving force and traveling resistance;
engaging, by a processor, the engine clutch via a synchronization process, when the processor determines that the engine clutch can be engaged within the time required for the current motor speed to reach the motor torque limit time speed;
determining, by the processor, whether the motor torque limit according to the discharge power is greater than a driver-requesting torque, when the processor determines that the engine clutch cannot be engaged within the time required for the current motor speed to reach the motor torque limit time speed; and
engaging the engine clutch via a slip process, when the motor torque limit is less than the driver-requesting torque.

6. The method of claim 5, wherein when the motor torque limit is greater than the driver-requesting torque, the synchronization process is performed.

7. A non-transitory computer readable medium containing program instructions executed by a processor, the computer readable medium comprising:
program instructions that calculate a discharge power according to a current status of a battery mounted within a hybrid vehicle;
program instructions that calculate a motor torque limit time speed wherein the motor torque limit speed is a motor speed at which a torque of a motor starts rapidly decreasing in accordance with the calculated discharge power;
program instructions that calculate a reference motor speed that ensures stable operation of an engine when an engine clutch is completely engaged, using a current driving force and traveling resistance of the vehicle;
program instructions that compare the motor torque limit time speed with the reference motor speed;
program instructions that engage the engine clutch via a synchronization process when the motor torque limit time speed is the reference motor speed or more, as the result of performing the speed comparison process;
program instructions that calculate determine whether the motor torque limit according to the discharge power is a driver-requesting torque, when the motor torque limit time speed is less than the reference motor speed; and
program instructions that engage the engine clutch via a slip process, when the motor torque limit is less than the driver-requesting torque.

8. The non-transitory computer readable medium of claim 7, wherein discharge power is calculated from a current temperature and a state of charge (SOC) of the battery.

9. The non-transitory computer readable medium of claim 7, further comprising:
program instructions that calculate an acceleration speed of the vehicle by using the current driving force and traveling resistance;
program instructions that calculate a necessary time to be taken to reach a vehicle speed that ensures stable operation of the engine when the engine clutch is completely engaged from the current vehicle speed by integrating the acceleration speed with an integration area from the current vehicle speed to the vehicle speed that ensures stable operation of the engine when the engine clutch is completely engaged;
program instructions that calculate a reference vehicle speed by integrating the acceleration speed of the vehicle to a reference vehicle speed, with an integration area from 0 to the necessary time;
program instructions that calculate a speed of an input shaft of a transmission in consideration of an effective radii of one or more driving wheels and the total reduction gear ratio of the vehicle in the reference vehicle; and
program instructions that set the speed of the input shaft of the transmission as the reference motor speed.

10. The non-transitory computer readable medium of claim 7, wherein when the motor torque limit is greater than the driver-requesting torque, the synchronization process is performed.
